(19) United States
(12) Patent Application Publication
(10) Pub. No.: US 2002/0126097 A1
(43) Pub. Date: Sep. 12, 2002

(54) Alphanumeric data entry method and apparatus using reduced keyboard and context related dictionaries

(76) Inventor: Sampo Jussi Pellervo Savolainen, Espoo (FI)

Correspondence Address: BANNER & WITCOFF, 1001 G STREET N W, SUITE 1100, WASHINGTON, DC, 20001, US

(21) Appl. No.: 09/799,490

(22) Filed: Mar. 7, 2001

(51) Int. Cl. G09G 5/00

(52) U.S. Cl. 345/168

(57) ABSTRACT

A method and apparatus for inputting alphanumeric data into an electronic device via a reduced keyboard using context related dictionaries. The keystroke sequence entered by a user is compared to entries in a dictionary containing keystroke sequences respectively associated with text. The dictionary used to determine the desired text to be input by a user is selected based upon the mode of operation of the electronic device. The use of context related dictionaries increases the efficiency of entering the alphanumeric text.

### BACKGROUND OF THE INVENTION

1. Field of the Invention

The present invention relates to a method and apparatus for entering alphanumeric data. In particular, the present invention relates to a method and apparatus for entering alphanumeric data into an electronic device from a reduced keyboard using context related dictionaries selected in accordance with the mode of operation of the electronic device.

2. Description Of Related Art

Portable computers and other personal electronic devices such as mobile phones, personal digital assistants, and pagers, are becoming increasingly powerful and popular. In addition to facilitating voice communication, these devices enable users to send and receive short messages, access the Internet, send and receive e-mails and faxes, and send control commands to automated devices. Therefore, these devices must support the entry of alphanumeric data as well as numeric data. The ability to enter text while meeting increasing demands for devices that are compact and user-friendly has proved to be a challenging task.

Recent portable electronic devices enable users to enter alphanumeric data by writing on a touch-sensitive panel or screen, or by using some type of keyboard. In order to meet size demands, devices have been developed that provide for the entry of text through a keyboard having fewer keys than the common QWERTY keyboard. These devices often include a keyboard having fewer keys than letters in the alphabet for the associated language. For example, many of the devices using reduced key keyboards use a three-by-four array of keys as used on a Touch-Tone telephone, where each of the keys corresponds to multiple characters. Various approaches have been developed for entering and displaying desired text using reduced keyboards.

One approach for entering the desired text from a reduced keyboard requires the user to enter an appropriate number of keystrokes to specify each letter. For example, on a keyboard such as a Touch-Tone telephone keyboard, in order to enter the word “call,” the user would enter the following keystrokes “2, 2, 2, 2, 5, 5, 5, 5, 5, 5” (three 2s for “c”, a single 2 for “a”, and three 5s for each “l”). This is often referred to as the “multi-tap” method or multiple keystroke method for entering text. Clearly, this type of text entry is tedious and time-consuming.

Another approach provides a reduced keyboard using word level disambiguation to resolve ambiguities in keystrokes, as set forth in U.S. Pat. No. 6,011,544. According to this approach, a user enters a keystroke sequence where each keystroke is intended to correspond to a letter of a word. The keystroke sequence is processed by comparing the sequence with sequences of words stored in vocabulary modules to obtain a list of all possible words stored in the dictionary corresponding to the keystroke sequence. Since each key corresponds to multiple characters, each keystroke sequence may match more than one word stored in the dictionary. The words that match the sequence of keystrokes are automatically displayed to the user as each keystroke is received. Multiple words that may match the sequence of keystrokes are provided to the user in a list, where the most frequently used word is shown first. The user chooses a select key to search for the desired word from the list corresponding to the keystroke sequence. New words may be added to the vocabulary modules by using the “multi-tap” or multiple keystroke method, for example. However, this and similar types of approaches suffer from the disadvantage of referencing the same dictionary of vocabulary modules regardless of mode of operation. Therefore, the size of the list for determining the desired text is the same regardless of the mode of operation.

It would be desirable to provide a method and apparatus that enables the entry of text via a reduced keyboard where the list of possible matches is limited based upon the mode of operation of the portable electronic device. It would further be desirable to provide a method and apparatus that enables the entry of text via a reduced keyboard, where the user is only required to enter one keystroke per letter of the desired text, and where the list of possible matches is limited based upon the mode of operation of the portable electronic device.

### SUMMARY OF THE INVENTION

It is an object to the present invention to provide a method and apparatus for entering alphanumeric data which overcomes the deficiencies of the prior art.

It is a further object of the present invention to provide a method and apparatus for entering alphanumeric data from a reduced keyboard by comparing keystroke sequences to words stored in context related dictionaries.

It is another object of the present invention to provide a method and apparatus for inputting alphanumeric data into an electronic device from a reduced keyboard where the dictionary used for determining the intended text is selected based upon the mode of operation of the electronic device.

It is yet a further object of the present invention to provide a method and apparatus for inputting alphanumeric data from a reduced keyboard where the text for a desired word may be completed before completing the keystrokes for the word when the keystroke sequence matches the keystroke sequence for a word in the associated dictionary.

These and other objects are achieved in a text input method and apparatus that provides for the input of alphanumeric data via a reduced keyboard using context related dictionaries, where the dictionary used to determine the desired text to be input by a user is selected based upon the mode of operation of the electronic device.

### BRIEF DESCRIPTION OF DRAWINGS

The invention will be described in detail in the following description of preferred embodiments with reference to the following figures wherein:

FIG. 1 illustrates a personal digital assistant incorporating a text input system;

FIG. 2 is a block diagram of the text input system shown in FIG. 1;

FIG. 3 is a flowchart of the steps performed according to the text input system shown in FIG. 1;

FIGS. 4A-4B are diagrams depicting the construction of a vocabulary module and associated object lists for the text input system of FIG. 1;

FIG. 5 is a flowchart of a subroutine for identifying objects contained in the vocabularly module depicted in FIGS. 4A-4B that correspond to a received keystroke sequence;

FIG. 6 is a front view of a portable electronic device including a reduced keyboard system according to an aspect of the present invention;

FIG. 7 is a block diagram of the basic components of the portable electronic device according to an aspect of the present invention;

FIG. 8 is a block diagram of the functional elements for entering text associated with an example according to the present invention;

FIG. 9 is a block diagram of the functional elements for entering text according to the present invention with respect to a specific example of entering text in the e-mail mode of operation;

FIG. 10 is a flow diagram of the steps for entering text according to an aspect of the present invention;

FIG. 11 shows the front view of a portable electronic device having text entered based upon the illustrated keystroke sequence;

FIG. 12 shows the dictionaries accessed for entering the text shown in FIG. 11; and

FIG. 13 shows the interaction between the portable electronic device and a server for entering the text shown in FIG. 11.

### DETAILED DESCRIPTION OF PREFERRED EMBODIMENTS

The present invention may be implemented using a variety of text input systems, such as the T9® Text Input technology from Tegic Communications, for example. The T9® Text Input technology is becoming popular for entering short messages due to its ability to enable users to enter text from a reduced keyboard using only one keystroke per letter of desired text instead of the usual multi-tap or multiple keystroke method. Therefore, in order to facilitate an understanding of the invention, a description for entering text using a single keystroke per letter will now be provided with reference to U.S. Pat. No. 6,011,554. However, it is to be understood that the present invention may be implemented with a variety of text input systems in addition to the system described herein.

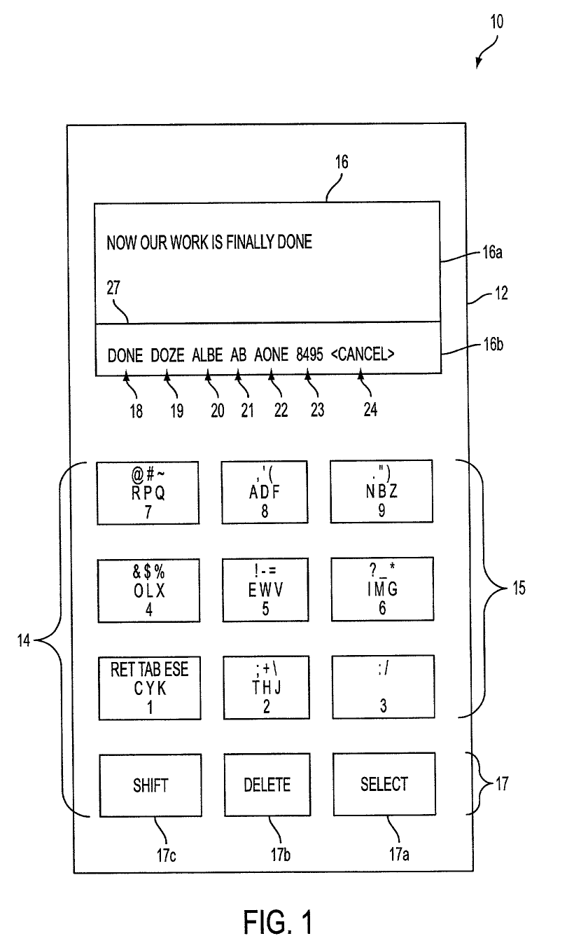

The description will be made with reference to the text input system 10 shown in FIG. 1. The system includes a keyboard 14 with a reduced number of keys. A plurality of letters and symbols are assigned to a set of data keys 15 so that keystrokes entered by a user are ambiguous. Due to the ambiguity in each keystroke, an entered keystroke sequence could match a number of words with the same number of letters. The text input system includes a memory having a number of vocabulary modules. The memory may include temporary storage media such as a random access memory (RAM), and permanent storage media such as a read only memory (ROM), floppy disks, hard disks, or CD-ROMs, for example. The vocabulary modules contain a library of objects that are each associated with a keystroke sequence. Each object is also associated with a frequency of use. Objects within the vocabulary modules that match the entered keystroke sequence are identified by the text input system. Objects associated with a keystroke sequence that match the entered keystroke sequence are displayed to the user in a selection list 27 on a display 16. The objects are listed in the selection list according to their frequency of use. A select key 17a is pressed by a user to delimit the end of a keystroke sequence. The first entry in the selection list is automatically selected by the system as the default interpretation of the ambiguous keystroke sequence. The user accepts the selected interpretation by starting to enter another ambiguous keystroke sequence. Alternatively, the user may press the select key 17a a number of times to select other entries in the selection list. For words that are not in the vocabulary modules, a two-stroke or multiple-stroke method may be used to unambiguously specify each letter. The system simultaneously interprets all entered keystroke sequences as a word, as a two-stroke sequence, and as a multiple-stroke sequence. The multiple interpretations are automatically and simultaneously provided to the user in the selection list.

With reference to FIG. 1, a text input system 10 is depicted incorporated in a personal digital assistant 12. The portable assistant 12 contains the reduced keyboard 14 and the display 16. Keyboard 14 has a reduced number of data entry keys from a standard QWERTY keyboard. In this example, the keyboard contains twelve standard full-sized keys arranged in three columns and four rows. More specifically, the keyboard contains nine data keys 15 arranged in a 3-by-3 array, and a bottom row of three system keys 17, including a select key 17a, a delete key 17b, a delete key 17b and a shift key 17c.

Data is input into the text input system via keystrokes on the reduced keyboard 14. As a user enters a keystroke sequence using the keyboard, text is displayed on the display 16. In this example, two regions are defined on the display to display information to the user. An upper text region 16a displays the text entered by the user and serves as a buffer for text input and editing. A selection list region 16b, located below the text region, provides a list of words and other interpretations corresponding to the keystroke sequence entered by a user. As will be described in additional detail below, the selection list region aids the user in resolving the ambiguity in the entered keystrokes. It will be appreciated by those of ordinary skill in the art that many arrangements are possible for the display, and these arrangements need not include separate regions as set forth in the current example.

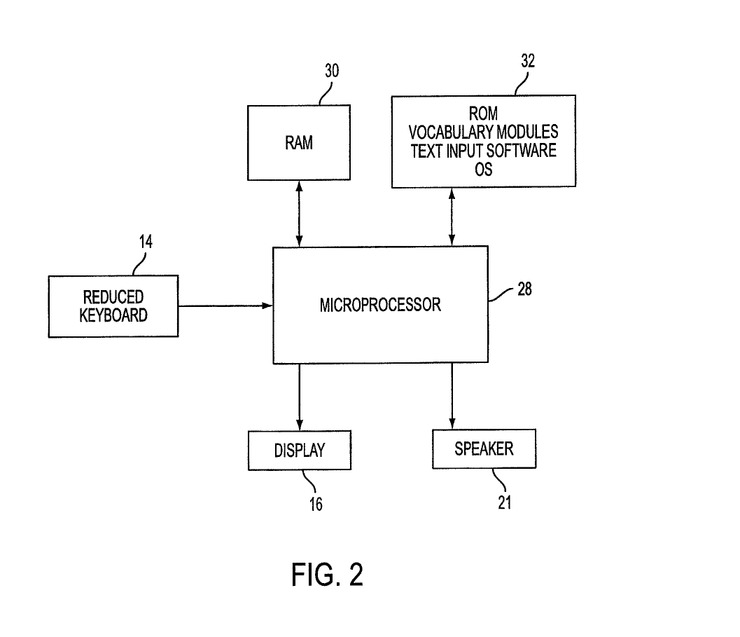

A block diagram of the text input system hardware according to the present example is provided in FIG. 2. The keyboard 14 and the display 16 are coupled to a microprocessor 28 through appropriate interfacing circuitry. A speaker 21 is also coupled to the microprocessor 28. The microprocessor 28 receives input from the keyboard, and manages all output to the display and speaker. Microprocessor 28 is coupled to a memory. The memory may include a combination of temporary storage media, such as random access memory (RAM) 30, and permanent storage media, such as read-only memory (ROM) 32. Memory 30, 32 contains all software routines to govern system operation. The memory may contain an operating system (OS), disambiguating software, and associated vocabulary modules that are discussed in additional detail below. Optionally, the memory may contain one or more application programs. Examples of application programs include word processors, software dictionaries, and foreign language translators. Speech synthesis software may also be provided as an application program, allowing the text input system to function as a communication aid.

Returning to FIG. 1, the text input system 10 allows a user to quickly enter text or other data using only a single hand. Data is entered using the data keys 15. Each of the data keys has multiple meanings, represented on the top of the key by multiple letters, numbers, and other symbols. (For the purposes of this disclosure, each data key will be identified by the symbols in the center row of the data key, e.g., “RPQ” to identify the upper left data key.) Since individual keys have multiple meanings, keystroke sequences are ambiguous as to their meaning. As the user enters data, the various keystroke interpretations are therefore displayed on the display to aid the user in resolving any ambiguity. A selection list 27 of possible interpretations of the entered keystrokes is provided to the user in the selection list region 16b. The first entry 18 in the selection list is selected as a default interpretation and displayed in the text region 16a at an insertion point 25.

The selection list 27 of the possible interpretations of the entered keystrokes may be ordered in a number of ways. In one mode of operation, the keystrokes are initially interpreted as the entry of letters to spell a word (hereinafter the “word interpretation”). Entries 18 and 19 in the selection list are therefore words that correspond to the entered keystroke sequence, with the entries ordered so that the most common word corresponding to the keystroke sequence is listed first. For example, as shown in FIG. 1, a keystroke sequence ADF, OLX, NBZ and EWV has been entered by a user. As keys are entered, a vocabulary module look-up is simultaneously performed to locate words that have matching keystroke sequences. The words identified from the vocabulary module are displayed to the user in the selection list 27. The words are sorted according to frequency of use, with the most commonly used word listed first. Using the example keystroke sequence, the words “done” and “doze” were identified from the vocabulary module as being the most probable words corresponding to the keystroke sequence. Of the two identified words, “done” is more frequently used than “doze,” so it is listed first in the selection list. The first word is also taken as the default interpretation and provisionally posted as highlighted text at the insertion point 25.

Following entry of the keystroke sequence corresponding to the desired word, the user presses the select key 17a. Pressing the select key draws a box around the first entry in the selection list 27 and redisplays the first entry at the insertion point 25 with a box around the entry. If the first entry in the selection list is the desired interpretation of the keystroke sequence, the user continues to enter the next word using the data keys 15. The text input system interprets the start of the next word as an affirmation that the currently selected entry (in this case, the first entry in the selection list) is the desired entry. Alternatively, the selection of the first entry may occur after a user-programmable time delay. The default word therefore remains at the insertion point as the choice of the user, and is redisplayed in normal text without special formatting.

If the first entry in the selection list is not the desired interpretation of the keystroke sequence, the user may step through the items in the selection list by repeatedly pressing the select key 17c. For each press of the select key, the next entry in the selection list is boxed, and the entry may be provisionally copied to the insertion point 25. Provisionally posting the next entry to the text region allows the user to maintain their attention on the text region without having to refer to the selection list. If the second entry in the selection list is the desired word, the user proceeds to enter the next word after two presses of the select key 17a and the system automatically posts the second entry to the text region as normal text. If the second entry is not the desired word, the user may examine the selection list and press the select key 17a a desired number of times to select the desired entry before proceeding to enter the next word. When the end of the selection list is reached, additional presses of the select key causes the selection list to scroll to view other entries to be added to the selection list. Those entries at the top of the selection list are removed from the list displayed to the user. The entry selected by multiple presses of the select key is automatically posted to the text region when the user presses any data key 15 to continue to enter text.

In the majority of text entry, keystroke sequences are intended by the user as letters forming a word. It will be appreciated, however, that the multiple characters and symbols on the keys allow the individual keystrokes and keystroke sequences to have several interpretations. Various different interpretations are automatically determined and displayed to the user at the same time as the keystroke sequence is interpreted and displayed to the user as a list of words.

For example, the keystroke sequence may be interpreted as word stems representing all possible valid sequences of letters that a user may be entering (hereinafter the “stem interpretation”). Unlike word interpretations, word stems are incomplete words. When stem interpretations are displayed as part of the selection list 27, the stem interpretations in the selection list are therefore not selectable by pressing the select key. By indicating the last keystrokes, however, the word stems allow the user to easily resume typing when his or her attention has been diverted in the middle of the word. As shown in FIG. 1, the keystroke sequence ADF OLX NBZ EWV has been interpreted as forming a valid stem “albe” (leading to the word “albeit”). The stem interpretation is therefore provided as entry 20 in the selection list. The stem interpretations may be sorted according to the frequency of the most probable words that can be generated from each stem. When listing a stem interpretation in the selection list, the stem is omitted if a stem interpretation duplicates a word that is shown in the selection list. When the stem is omitted, however, the word corresponding to the omitted stem is marked with a symbol to show that there are also words of longer length having this word as their stem. Stem interpretations provide feedback to the user by confirming that the correct keystrokes have been entered to lead to the entry of a desired word.

Each pair of keystrokes is also interpreted as specifying a single character using a two-stroke specification method (hereinafter the “two-stroke interpretation”). The data keys 15 contain up to nine characters that are arranged in a 3-by-3 array on the top of each key. The first keystroke in each two-stroke pair of keystrokes is ambiguous—it tells the system that the user wishes to choose one of the nine characters grouped on the depressed key, but it does not specify which character.

The second keystroke qualifies or disambiguates the first. The position of the second keystroke in the 3-by-3 array of data keys specifies the character to be chosen from the 3-by-3 array of characters on the top of the first key. Each pair of keystrokes is therefore also interpreted by the text input system and automatically presented to the user in the selection list. For example, as shown in FIG. 1, the entry of a keystroke sequence ADF and OLX first designates the top center data key, then the character on that key in the left position of the second row, namely, the letter “a”. The next two keystrokes NBZ and EWV designate the top right data key, then the symbol in the center position of the second row, namely, the letter “b”. The two-stroke interpretation “ab” is therefore provided as an entry 21 in the selection list. It will be appreciated that the two-stroke interpretation may also be reversed, with the first keystroke qualifying or disambiguating the second. A second method is also employed in which a sequence of keystrokes is interpreted as unambiguously specifying a specific string of alphabetic characters as in the multiple keystroke method.

The keystroke sequence is also interpreted as a string of numerical digits (hereinafter the “numeric interpretation”). Data keys 15 contain characters representing numerical digits. One of the interpretations provided in the selection list is therefore the numerical digits that correspond to the keystroke sequence. For example, entry 23 is the numeric interpretation (“8495”) of the keystroke sequence ADF, OLX, NBZ, EWV.

Finally, any keystroke sequence may be given additional meanings by linking the keystroke sequence to an object in a vocabulary module (discussed below). For example, as shown in the selection list in FIG. 1, the keystroke sequence may be interpreted and presented as an entry 24 that corresponds to a system command or system menu. The system command “<cancel>” corresponds to a system macro object that cancels the current key sequence. Entry 24 may also correspond to a system menu. Selecting an entry labeled “<delete>”, for example, may cause a number of menu items such as “delete file” or “delete paragraph” to be displayed in the selection list. The user would select the appropriate menu item by pressing the select key to box the desired item. Those skilled in the art will recognize that other system commands or system menus may also be defined in the system.

As noted above, in the normal mode of operation the entries in the selection list 27 corresponding to words are presented first in the list. In other circumstances, it may be desirable to have other keystroke sequence interpretations presented first in the list. For example, in situations where a series of numbers are to be entered, it would be desirable to have the numeric interpretation of the keystroke sequence presented first. The text input system therefore allows a user to select between other modes of operation by accessing a system menu. In a numeric mode of operation, the first interpretation provided in the selection list is the number corresponding to the keystroke sequence. In a two-stroke specification mode, the two-stroke interpretation is provided first in the selection list. The two-stroke specification mode therefore allows the user to enter a large number of words that must be spelled because they are not contained in the system vocabulary modules. Each of these modes of operation changes the ordering of the selection list displayed to the user.

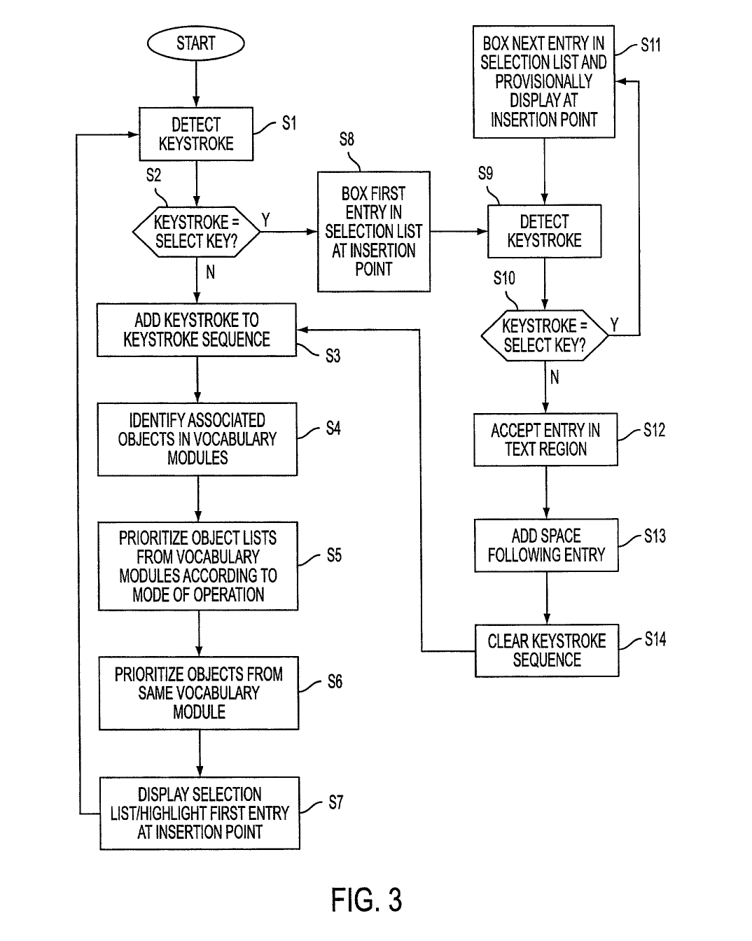

The operation of the reduced keyboard system is governed by the software stored in ROM 32. FIG. 3 is a flowchart of a main routine of the software that generates a selection list to aid the user in disambiguating ambiguous keystroke sequences. At step SI, the system waits to receive a keystroke from the keyboard 14. At step S2, a test is made to determine if the received keystroke is the select key. If the keystroke is not the select key, at step S3 the keystroke is added to a stored keystroke sequence.

At S4, objects corresponding to the keystroke sequence are identified from the vocabulary modules in the system. Vocabulary modules are libraries of objects that are associated with keystroke sequences. An object is any piece of stored data that is to be retrieved based on the received keystroke sequence. For example, objects within the vocabulary modules may include numbers, letters, words, stems, phrases, or system macros.

A tree data structure is used to organize the objects in a vocabulary module based on a corresponding keystroke sequence. Each node N₁, N₂, . . . N₉ in a vocabulary module tree represents a particular keystroke sequence. The nodes in the tree are connected by paths P₁, P₂, . . . P₉. Since there are nine ambiguous data keys in this embodiment of the system, each parent node in the vocabulary module tree may be connected with nine children nodes. Nodes connected by paths indicate valid keystroke sequences, while the lack of a path from a node indicates an invalid keystroke sequence. The vocabulary module tree is traversed based on a received keystroke sequence. Each node is associated with a number of objects corresponding to the keystroke sequence. As each node is reached, an object list is generated of the objects corresponding to the keystroke sequence. The object list from each vocabulary module is used by the main routine of the text input system to generate a selection list 27.

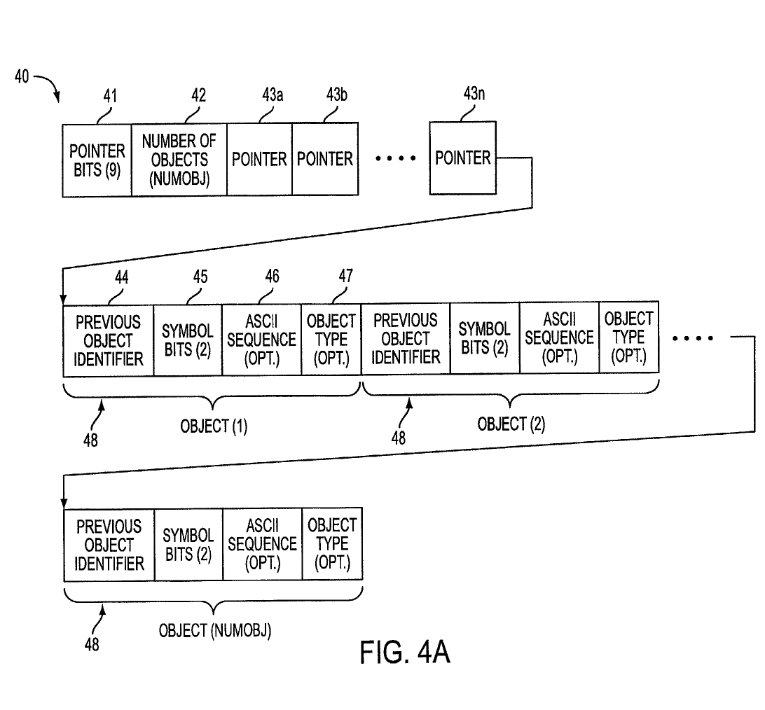

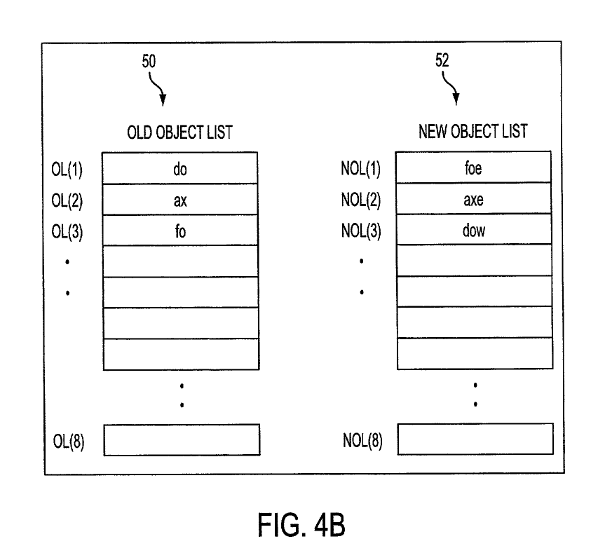

FIG. 4A is a block diagram of a possible data structure 40 associated with each node. The data structure contains information that links each parent node to children nodes in the vocabulary module tree. The data structure also contains information to identify the objects associated with the particular keystroke sequence represented by the node.

The first field in the node data structure 40 is a pointer bits field 41 that indicates the number and identity of children nodes that are connected to the parent node. Since there are nine data keys, only nine children nodes may be connected to any parent node. In this embodiment, nine pointer bits are therefore provided in the pointer bits field to indicate the presence of a child node. Each pointer bit is associated with a pointer field 43a, 43b, . . . 43n that contains a pointer to the respective child node data structure in the vocabulary module. Since a child node is only present if the keystroke associated with the child node forms part of a valid keystroke sequence with the keystroke sequence associated with the parent node, the number of pointer fields varies for each node. For example, pointer bits field 41 may indicate that only six of the possible nine keystrokes lead to a valid child node. Because there are only six valid paths, only six pointer fields 43a, 43b, . . . 43f are included in the data structure for the parent node. The pointer bits field 41 is used to ascertain the identity of the pointer fields contained within the node data structure. If a keystroke does not lead to a valid child node, the associated pointer field may be omitted from the node data structure in order to conserve the amount of memory space required to store the vocabulary module.

Associated with each node are a number of objects that correspond to the keystroke sequence represented by the node. For each node, a number of objects field 42 is provided to indicate the number of objects (NUMOBJ) associated with the node. Since each node is associated with one and only one keystroke sequence, the number of objects associated with any given node is a constant. Each of the objects is associated by an object packet 48 contained in the node data structure. The number of objects field 42 specifies the number of object packets 408 that are present in the node data structure.

Each object packet 48 describes one object corresponding to the keystroke sequence represented by each node. Describing an object requires maintaining two object lists. FIG. 4B depicts representative object lists created for a parent and a child in a vocabulary module tree. Object list 50 is an object list containing objects OL(1)-OL(8) associated with a node representing two keystrokes. Object list 52 is an object list containing objects NOL(1)-NOL(8) associated with a node representing three keystrokes. Each object list contains a list of all objects that are associated with each node. Object list 50 is associated with a parent node representing the keystroke sequence ADF OLX. Object list 52 is associated with a child node representing the keystroke sequence ADF OLX EWV. Although a maximum of eight entries are depicted as capable of being stored in each object list, it will be appreciated that the size of the object list may be varied to account for the maximum number of objects associated with each node.

Each object associated with a child node is constructed by adding a character sequence onto an object that was constructed for the parent node. The object packet 48 therefore contains a previous object identifier field 44 that identifies from a parent node object list an object that is used to construct the child node object. For example, with reference to FIG. 4B, the third object “fo” in the old object list 50 is used to construct the first object “foe” in the new object list 52. The previous object identifier field 44 therefore provides a link to the entries in the old object list to identify the old object used to construct the new object.

The object packet 48 contains a two-bit symbol field 45 to indicate the symbol to add to the identified object in order to construct the new object. In the preferred embodiment, each ambiguous key contains a maximum of three letters. The symbol field bits therefore specify the letter from each key that is used to construct the new object using the following binary code: “00” corresponds to the first letter on the key, “01” corresponds to the second letter on the key, and “10” corresponds to the third letter on the key. For example, with reference to FIG. 4B, the first object “FOE” in the new object list 52 is constructed by using the third object “FO” in the old object list 50 and adding an additional keystroke to specify the E. In the preferred keyboard arrangement, “E” is the first letter on the EWV key, therefore the symbol field corresponding to the object “FOE” is set to “00” to indicate the first letter on the key. Encoding the objects in this manner greatly reduces the amount of storage space required for each vocabulary module. The encoding technique also allows direct access to vocabulary module entries without searching. Rather than having to store every object in the vocabulary module, a new object is defined using the two-bit code to add onto an old interpretation. The disclosed storage method requires, however, maintaining an object list from a parent in the vocabulary module tree in order to construct an object list of the child.

Symbol field 45 may also be set to the value “11”. When set to the value “11”, the symbol field indicates the presence of an ASCII sequence field 46 immediately following the symbol field. The ASCII sequence field is used to store strings of characters that are to be appended to the identified object. For example, the ASCII sequence field may store the string “rward” to be added to the third object “fo” from the old object list to form the word “forward”. In this manner, the length of an entered keystroke sequence does not necessarily directly correspond to the length of an associated object. The ASCII sequence field allows a vocabulary object to be identified by an arbitrary key sequence, i.e., stored at an arbitrary location within the vocabulary module tree.

The capability of storing objects with an arbitrary keystroke sequence is used to speed system processing of abbreviations and contractions. Abbreviations and contractions are typically identified by a keystroke sequence that corresponds to their pure alphabetic content, ignoring punctuation. The result is that abbreviations and contractions are easily accessed by the user without entering punctuation, resulting in a significant savings in keystrokes. For example, the user can enter the keystroke sequence for “didnt” without adding an apostrophe between the “n” and the “t”. The word in the vocabulary module that corresponds to the keystroke sequence “didnt” contains an ASCII sequence field with an apostrophe between the “n” and the “t”. The disambiguating system will therefore automatically display to the user the correct word “didn't”, without requiring the user to enter the punctuation mark. The disambiguating system uses the same technique to properly display foreign words having unique characters (such as “U”, which may be entered as a “U”). Capitalization may be handled in a similar manner. Words that should always be used in all capital letters, with an initial capital letter, or with a capital letter in the middle are identified by keystroke sequences without keystrokes indicating capitals, eliminating the need for the user to enter such capitalization.

An object type field 47 may also be included in each object packet 408 to specify additional information about the object being constructed. The object type field may contain a code to specify whether the generated object is a word, a word stem, or any other object. The object type field therefore allows different types of objects to be mixed within a given vocabulary module. Moreover, the object type field may also include information regarding the part of speech of the word, information about how the object is capitalized, or information needed to construct various inflections and endings. A text input system using a vocabulary module having the part of speech information may use the additional information to implement syntactical analysis to improve the disambiguation process. The object type field may also contain a unique code to allow transmission of text in a compressed form. The unique code would be transmitted to a remote terminal instead of transmitting the entered keystroke sequence or the associated disambiguated characters.

One of the features of the vocabulary module tree data structure is that the objects associated with each node are stored in the node data structure 40 according to their frequency of use. That is, the first object packet 48 has a higher frequency of use than the second object packet in the node data structure, which has a higher frequency of use than the third object packet. In this manner, the objects are automatically placed in the object list so that they are sorted according to decreasing frequency of use. For purposes of this description, frequency of use refers to the likelihood of using a given word within a representative corpus of use, which is proportional to the number of times that each word occurs in the corpus.

While the objects are stored within the node data structure 40 in order according to their frequency of use, it will be appreciated that a frequency of use field could also be associated with each object packet. The frequency of use field would contain a representative number that corresponds with the frequency of use of the associated object. The frequency of use between different objects would be determined by comparing the frequency of use field of each object. The advantage of using the latter construction that associates a frequency of use field with each object packet is that the frequency of use field could be changed by the disambiguating system.

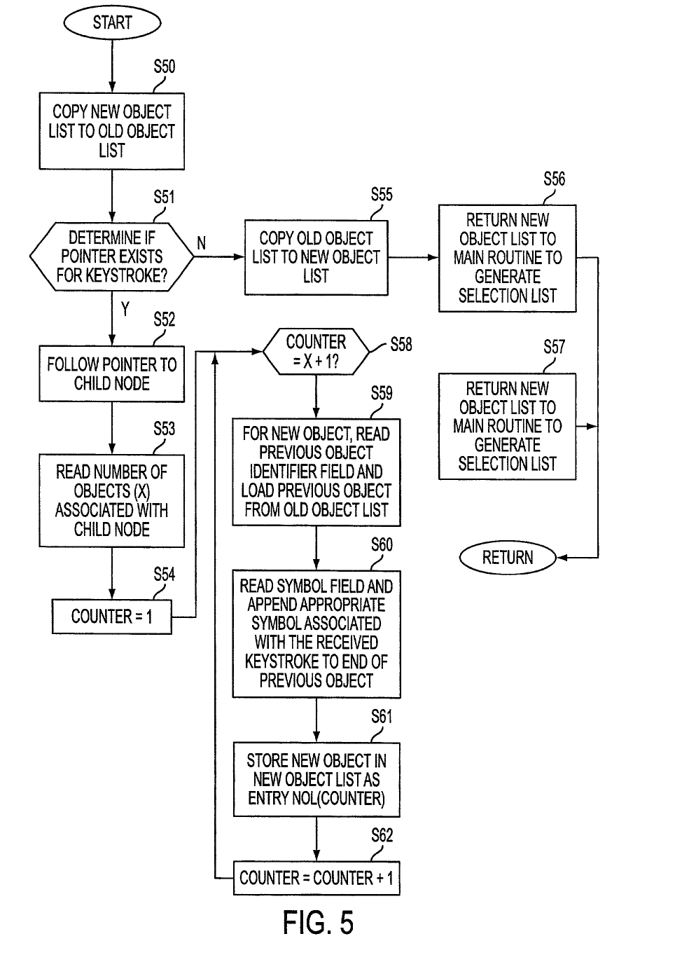

Returning to FIG. 3, at step S4 objects that correspond to the received keystroke sequence are identified in each vocabulary module. FIG. 5 is a flowchart of a subroutine for analyzing the received keystroke sequence to identify corresponding objects in a particular vocabulary module. The subroutine constructs an object list for a node representing a particular keystroke sequence. As noted above, to construct a new object list the system starts with a copy of the old object list. At a step S50, the object list from the prior node is therefore stored so that it may be used to construct the new object list.

In the main routine shown in FIG. 3, a keystroke was detected by the system at step SI. The receipt of a new keystroke causes a downward traversal in the vocabulary module tree, if a valid path exists to a child corresponding to the keystroke. At step S51 in FIG. 5, the pointer bits field of the parent node data structure is therefore examined to determine if a pointer corresponds to the received keystroke. At step S51, a test is made of the pointer bits field to determine if a pointer field 43a, 43b, . . . 43n exists that corresponds to the entered keystroke. If no pointer field corresponds to the keystroke, at step S55 the old object list is copied to the new object list. At step S56, the object list is returned to the main routine to generate the selection list. Since the received keystroke is part of an invalid keystroke sequence that does not correspond to any object within the vocabulary module, the keystroke is ignored and the current object list is returned to the main routine as being the object list from the vocabulary module. The branch of the subroutine including steps S55 and S56 therefore ignores any invalid keystroke sequences and returns the object list generated at the parent node for possible inclusion in the selection list generated by the text input system.

If a pointer exists corresponding to the received keystroke at step S51, the subroutine proceeds to step S52 where the pointer is followed to the child node representing the keystroke. When the child node is identified, a new object list corresponding to the node must be constructed. On identifying the child node, the number of objects associated with the node is determined in step S53 from the number of objects field 42 in the child node data structure.

After determining the number of objects to be generated at the child node, the subroutine enters the loop comprised of steps S54, and S58 through S62 to reconstruct the object list associated with the child node. At step S54, a counter is initially set to one. At step S58, a test is made to determine if the counter has exceeded the number of objects associated with the node. If the counter has not exceeded the number of objects associated with the node, at step S59 the previous object identifier field 44 is examined and the corresponding object loaded from the old object list. At step S60, the symbol field 45 is examined and the appropriate symbol associated with the received keystroke appended to the end of the identified object. It will be appreciated that an additional ASCII sequence may also be appended to the identified object at step S60 if the symbol field indicates the presence of an ASCII sequence field 46 in the node data structure. At step S61, the combined object and symbol are stored as a new object in the new object list. After storing the new object in the object list, at step S62 the counter is incremented by one. The subroutine then loops to step S58 to determine whether all of the objects associated with the node have been constructed.

If the test at step S58 indicates that all of the objects have been constructed for the node, the subroutine proceeds to step S57 where the new object list is returned to the main routine in order to generate the selection list. It will be appreciated that the subroutine for generating the object list associated with each node is performed for each keystroke received from the user. No “searching” of the vocabulary modules is performed as the user enters a new keystroke sequence, since each keystroke merely advances the subroutine one additional level within the vocabulary module tree. Since a search is not performed for each keystroke, the vocabulary module returns the list of objects associated with each node in a minimal period of time.

It will be appreciated that the relationship between vocabulary module objects and keystroke sequences is an implementation detail of the vocabulary module. If only a limited number of objects (i.e., fewer than a predetermined number) are associated with a particular node, additional nodes may be traversed to identify objects having a keystroke sequence starting with the entered keystroke sequence. The objects are identified by traversing downward in the vocabulary module tree along valid paths until the objects are identified. The objects are then placed in the selection list before all the keystrokes corresponding to the objects are entered. The objects are included in addition to the objects that are directly associated with the input keystroke sequence. Displaying objects associated with longer keystroke sequences in the selection list (hereinafter referred to as the “look-ahead” feature) allows the user to optionally select the objects immediately, without having to complete the remaining keystrokes to specify the object. The look-ahead feature is enabled when the number of objects identified in the vocabulary modules fails to fill the selection list region 16b on the display.

Returning to FIG. 3, at steps S5-S7 the objects returned from the search of the vocabulary modules are prioritized and displayed to the user in the selection list 27. To determine the sequence of objects displayed in the selection list, priorities are established between each vocabulary module and also between the returned objects from each vocabulary module. After the priorities between the objects have been resolved, at step S7 a selection list is constructed from the identified objects and presented to the user. As a default interpretation of the ambiguous keystroke sequence entered by the user, the first entry in the selection list is provisionally posted and highlighted at the insertion point 25 in the text region 16a. The software routine then returns to step S1 to wait for the next keystroke.

If the detected keystroke is a select key, the “yes” branch is taken from the decision at step S2 to step S8. At step S8, a box is placed around the first entry in the selection list, and at the insertion point where it has been provisionally posted. At step S9, the system then waits to detect the next keystroke entered by the user. At step S10, a test is made to determine if the next keystroke is the select key. If the next keystroke is the select key, at step S11 a box is placed around the next entry in the selection list and the entry is provisionally displayed at the insertion point with a box around the entry. The routine then returns to step S8 to detect the next keystroke entered by the user. It will be appreciated that the loop formed by steps S8-S11 allows the user to select various interpretations of the entered ambiguous keystroke sequence having a lesser frequency of use by depressing the select key multiple times.

If the next keystroke is not the select key, from step S10 the routine continues to step S12 where the provisionally displayed entry is selected as the keystroke sequence interpretation and is converted to normal text formatting in the text region. At step S13, a space is added following the selected interpretation, since the receipt of an ambiguous keystroke following the select key indicates to the system the start of a new ambiguous sequence. At step S14, the old keystroke sequence is cleared from the system memory. The newly received keystroke is then used to start the new keystroke sequence at step S3. Because the word interpretation having the highest frequency of use is always presented as the default choice, the main routine of the software allows a user to continuously enter text with a minimum number of instances where additional activations of the select key are required.

Audible tones indicate the state of selection list 27 and provide feedback about keystrokes to allow system information to be conveyed independently of any visual feedback provided in the selection list. Distinct tones indicate when the selection list is empty, when it contains a single unique word, and when it contains multiple ambiguous words. Another tone indicates when the second or third entry in the selection list has a frequency of use above a preset threshold, or when the difference in frequency between the first and second word falls below a selected threshold. Still other tones distinguish the type of item being selected in the selection list as the select key is pressed. Separate tones are therefore used to distinguish words, numbers, proper nouns, phrases, system macros, etc. Distinct tones can also be assigned to each key to allow identification of mistakes in keystrokes. Finally, a unique tone is heard when the user presses a key that is unavailable for a word as described above.

Additional auditory feedback may be provided to the user by including a voice synthesizer as an application program in the text input system. As a user enters keystrokes, the voice synthesizer announces the first entry in the selection list. To allow typing to proceed unimpeded, the first entry is announced after a slight delay. The user may also cause the first entry to be spoken immediately by pressing the select key. The auditory feedback provided by a voice synthesizer allows visually-impaired users to use the system without having to view the selection list.

The system supports the mapping of single keys to any text input system command, menu, or symbol. The English language only contains two one-letter words (“A” and “I”) that must be presented as the first choice in the selection list when the respective single keys are pressed. Pressing any of the other data keys 15 that do not contain “A” or “I” can therefore be used to list a system command, a menu, or a symbol as the first item in the selection list.

It will be appreciated that a variety of keying techniques may be implemented in the text input system, depending on the keyboard construction. In addition to operating in different modes of operation wherein the selection list 27 is ordered to present a selected type of keystroke interpretation as the first entry in the list, the system 10 also may enter via a system menu a number of dedicated modes wherein only one interpretation is made for each key and only one or no entries are displayed in the selection list. For example, in a dedicated numeric mode, each keystroke corresponds to the entry of a number. In a dedicated cursor movement mode, each of the outside circles of data keys corresponds to a cursor movement direction to allow a user to manipulate a cursor in an application program.

The output from the text input system 10 is generally provided to other application programs running on and sharing the resources of the disambiguating system. Text is therefore directly entered into the application program using the aid of a selection list, such as shown in the system of FIG. 1A.

In other instances, the target for output is an application program running on a separate platform. For example, a user may desire to transfer entered text to a remote terminal. Those skilled in the art will recognize that a PCMCIA card or modem card may be added to computer 12 to allow data transfer with other devices. Text may be transferred after the entry of each word, or after an explicit “send” function accessed by the user via a system menu.

Among the vocabulary modules contained in the text input system 10 is a custom vocabulary module. Words entered using the two-stroke or multiple-stroke methods may be automatically stored by the disambiguating system in the custom vocabulary module. The words stored in the custom vocabulary module will thereafter be automatically displayed in the selection list when the user enters the shorter sequence of single (ambiguous) keys for these words.

In addition to adding words to the custom vocabulary module during normal text entry, words may also be added to a user's custom vocabulary module from a variety of other sources. For example, documents may be downloaded into the system and parsed to identify proper nouns or other words that are not contained in the vocabulary modules present in the system. After parsing, the newly identified proper nouns and words are added to the user's custom vocabulary module. Custom vocabulary modules may also be uploaded or downloaded to other systems or to a mass storage medium. A user may therefore merge their present custom vocabularies with other vocabularies created by another user.

The words in the selection list 27 identified from the standard vocabulary modules are usually presented to the user in the same order, according to decreasing frequency of use, so that the user can commit to memory the keystrokes necessary to enter a desired word.

The foregoing text input system, as well as other similar text input systems, are used to enter messages into portable electronic devices having a reduced keyboard. In these types of text input systems, reference is made to the same database or dictionary for obtaining potential matches to entered keystroke sequences. For example, in the text input system described above, the selection list 27 is identified from the standard vocabulary modules. The list is prioritized after reference is made to the standard vocabulary modules.

The present invention provides for use of text entry technology such as that described above in various modes of operation, where the dictionary used for determining possible matches for keystroke sequences is selected based upon the mode of operation of the electronic device. In this manner, the amount of data required to determine the desired text may be limited based upon the mode of operation. Consequently, the speed at which text may be entered by a user is increased.

In order to facilitate a description of the invention, a specific example of incorporating the present invention into a mobile telephone applying the English language is described. However, it will be appreciated by those of ordinary skill in the art that the present invention may be incorporated into any suitable electronic device using a variety of other alphabets for entering text in various languages.

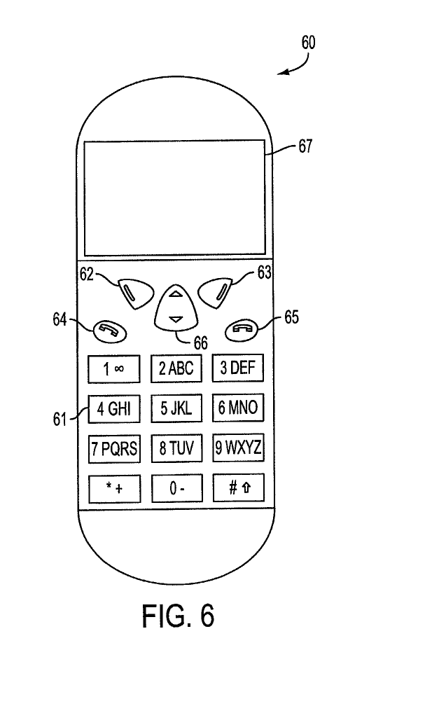

Referring to FIG. 6, a mobile telephone 60 is illustrated including a reduced keyboard 61. For purposes of this application, the term “reduced keyboard” is broadly defined to include, for example, any input device having mechanical keys, membrane keys or defined areas of a touch screen, where the number of keys or touch areas is less than the characters in the alphabet in use. In the embodiment shown in FIG. 6, the reduced keyboard is arranged in a three-by-four array of keys where each key corresponds to multiple characters, similar to a Touch-Tone telephone. In addition, the mobile telephone 60 includes control keys 62, 63, 64, 65, 66, and a display 67. Control keys 62, 63 and 66 are provided to control the information to be displayed on the display 67 and the selection of particular modes of operation. Control keys 64 and 65 are provided to initiate and terminate communication to/from the mobile telephone 60. Of course, many other arrangements may be possible for the reduced keyboard and the control keys.

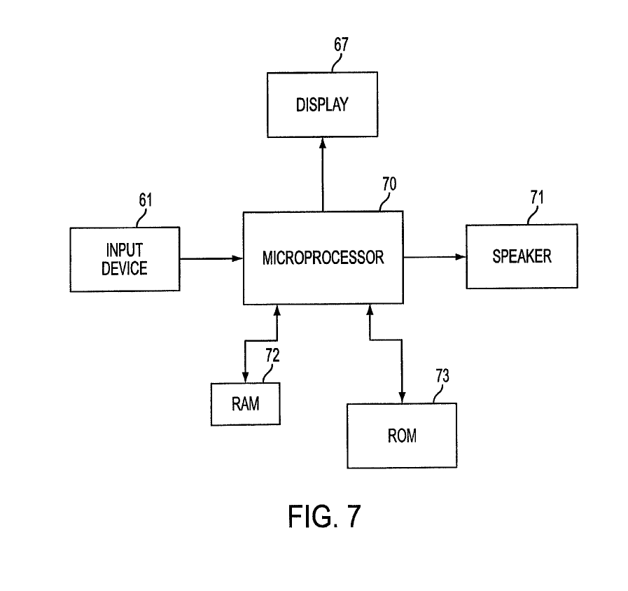

A block diagram of the mobile telephone 60 for use with the present invention is shown in FIG. 7. The mobile telephone 60 includes a microprocessor 70 coupled to an input device 61, such as the reduced keyboard 61, the display 67, a speaker 71, a temporary storage device such as RAM 72, and a permanent storage device such as ROM 73. ROM 73 stores the program software for operating the mobile telephone 60, including the software for implementing the present invention, as well as possible application programs.

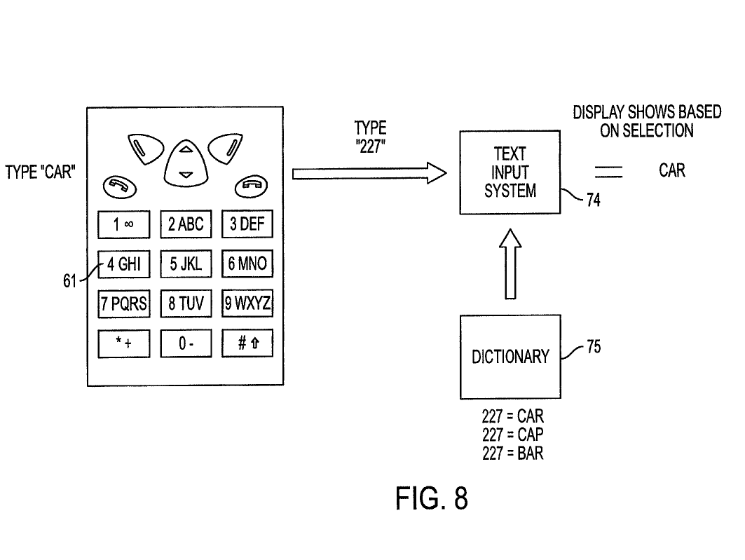

According to the present invention, alphanumeric data may be entered via the reduced keyboard 61, as shown in FIG. 8. The keystroke sequence entered onto the reduced keyboard by the user is processed by a text input system 74 so that the desired text ultimately appears on display 67. The text input system 74 may utilize dictionary 75 to provide the text that corresponds to the keystroke sequence entered by the user. The present invention may be implemented using any of a variety of text input system technology. For purposes of discussion, the present invention will be discussed with respect to the text input technology described herein with reference to FIGS. 1-5.

According to the present invention, the dictionary selected to interpret a keystroke sequence entered by a user depends upon the mode of operation of the mobile telephone 60 or portable electronic device. The determination is made by the microprocessor 70 based upon the mode of operation selected by the user. More particularly, the microprocessor 70 may detects the mode of operation based upon the user interface associated with the selected program or by the particular field for a user interface of the associated program into which data is being entered, for example. For instance, if it is determined that the mode of operation of the mobile telephone 60 is set to initiating a call, the dictionary accessed to interpret the keystroke sequence entered by the user is the list of names in the phonebook stored on the mobile telephone 60. The amount of possible matches is limited to only those entries stored in the phonebook. Since the keystroke sequence entered by the user is compared to the dictionary including only the names in the phonebook, the list of possible matches may be detected and displayed at a faster rate. Consequently, alphanumeric data may be entered into the mobile telephone 60 or any portable electronic device more efficiently.

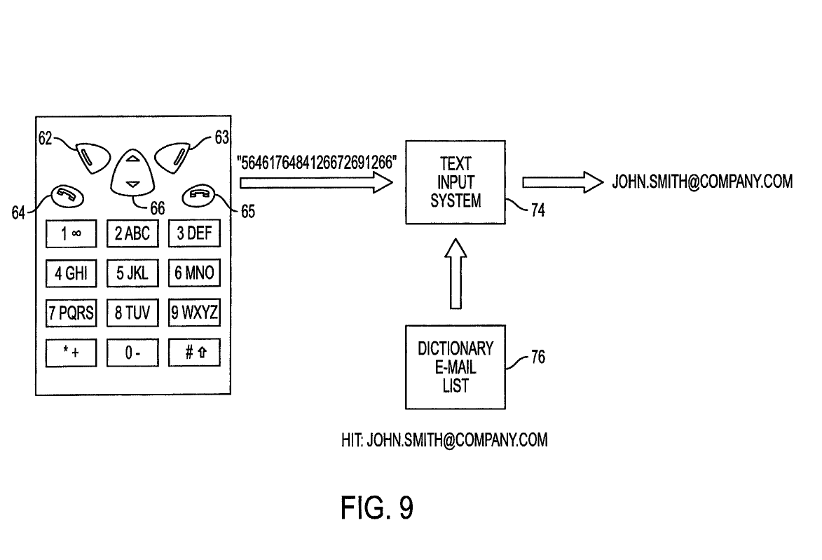

A specific example of the present invention will be described with reference to FIG. 9. In this example, the user manipulates appropriate ones of the control keys 62, 63, and 66 to set the mode of operation of the mobile telephone 60 to the e-mail mode of operation. The user intends to send an e-mail to a colleague John Smith. Entering the text in accordance with the text input technology, for example, the user enters the keystroke sequence “56461764841.26672691266”. Based upon the detected mode of operation, the microprocessor 70 selects the e-mail dictionary 76 to interpret the keystroke sequence. The keystroke sequence is then processed as each keystroke is detected and processed by the text input system 74 by comparing the keystroke sequence with entries in the e-mail dictionary 76. In this particular example, the keystroke sequence results in a hit in the e-mail dictionary 76 to the e-mail address John.Smith@company.com. The hit is shown on display 67 and the user initiates the e-mail by activating control key 64. Since the keystroke sequence is compared to the dictionary containing only e-mail addresses, the desired e-mail address may be obtained quickly.

It will be appreciated by those of ordinary skill in the art that e-mail is only one of a vast number of possible modes of operation for the mobile telephone 60 or for any portable electronic device. For example, other possible modes of operation may include accessing the Internet, entering contact information, sending/receiving faxes or files, etc.

Although the example is described with respect to the text input technology described with reference to FIGS. 1-5, it will be appreciated by those of ordinary skill in the art that any appropriate text input system may be used, including those that provide for text completion, where the desired text may be completed after only a few keystrokes.

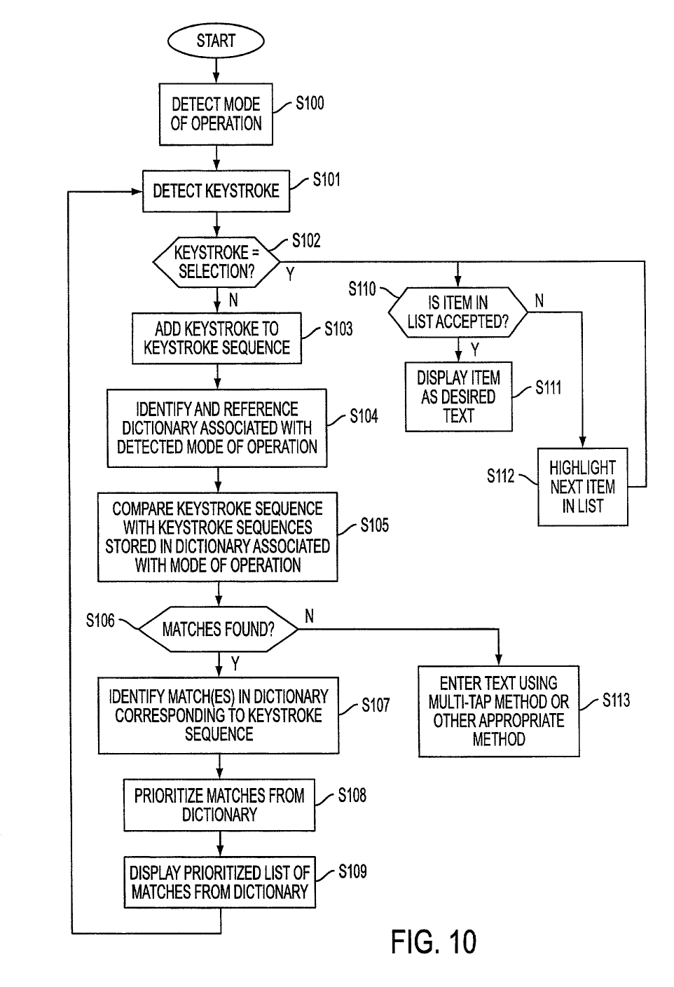

A process for entering alphanumeric data from a reduced keyboard according to the present invention is illustrated in FIG. 10. The electronic device is activated and the mode of operation is detected in step S100. In the mobile telephone example, the microprocessor 70 may detect the mode of operation based upon the user interface associated with the selected program or by the particular field for a user interface of the associated program into which data is being entered, for example. In step S101, the entry of a keystroke is detected. It is then determined whether the keystroke corresponds to a selection in step S102. When the answer in step S102 is Yes, processing continues to step S10. If the answer in step S102 is No, processing continues to step S103. In step S103, the detected keystroke is added to the keystroke sequence. In step S104, the appropriate dictionary associated with the program or data field is selected, and the keystroke sequence is compared to entries of the appropriate dictionary in step S105. In step S106, it is determined whether any matches are found. If the answer in step S106 is No, processing continues to step S113 where the text is entered into the appropriate dictionary via the multi-tap method or some other appropriate method. If the answer in step S106 is Yes, then the match or matches resulting from the comparison are identified in step S107, and in step S108, the matches are arranged in a prioritized list. Usually, the matches are prioritized according to frequency of use. However, those of ordinary skill in the art may find other criteria for prioritizing the matches. The prioritized list of matches for the keystroke sequence is then displayed in step S109, and processing returns to step S101.

When the answer in step S102 is Yes, processing continues to step S110 where it is determined whether the item has been selected by the user. The selection may be determined by entering the selection keystroke again, for example. If the answer in step S110 is Yes, then the selected word is displayed as the desired text in step S111. If the answer in step S110 is No, then the next item in the prioritized list of matches is highlighted or indicated in some manner in step S112. Processing then continues to step S110 until the desired text is selected.

The software for implementing the present invention may be application-independent so that it may operate with multiple application programs running on the portable electronic device. In addition, the dictionary may be in the electronic device itself or on a server.

The invention may be used for entering data onto forms in the wireless application protocol (WAP). WAP is one of the global open standards for applications over wireless networks. It provides a uniform technology platform with consistent content formats for delivering Internet and Intranet based information and services to wireless devices. WAP applications include wireless access to Internet content having immediate interactive access to the information needed, wireless access to personal information such as access to e-mail, calendars, etc.

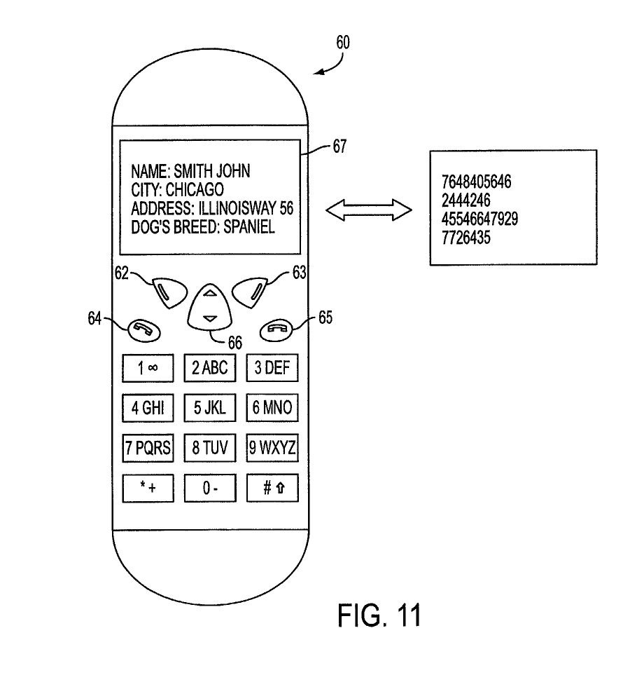

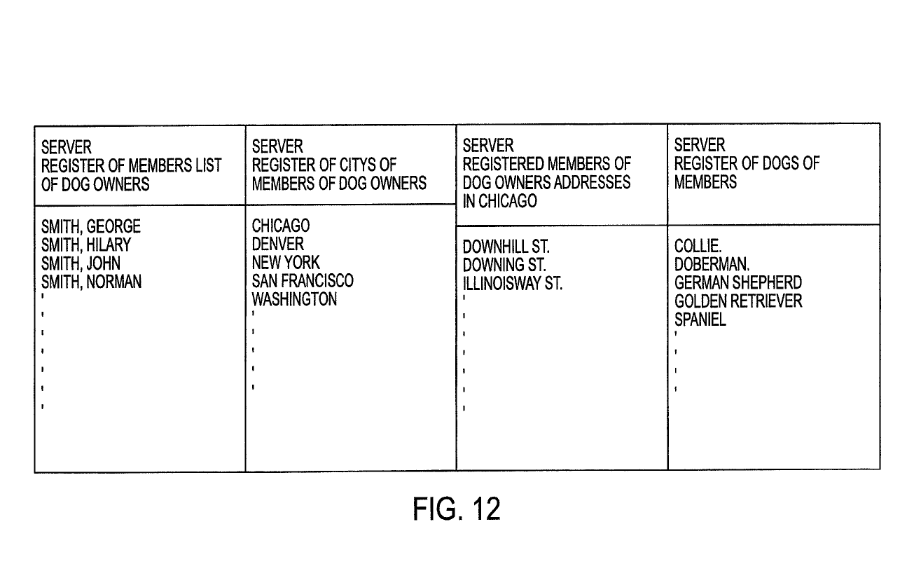

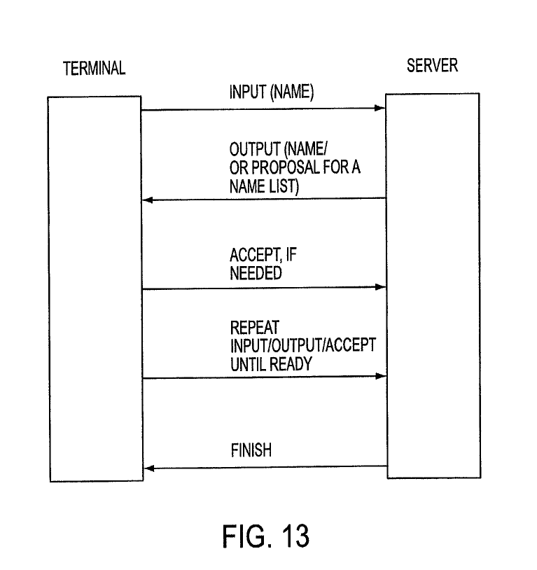

An example of entering alphanumeric data into fields associated with a particular program will be described with reference to FIGS. 11-13 In FIG. 11 a user enters the name John Smith, last name first, by entering the keystroke sequence “7648405646.” For purposes of this example, continue assuming text is entered according to the text input technology of FIGS. 1-5. The keystroke sequence is compared against a dictionary containing a member list of registered dog owners stored on a server, as shown in FIG. 12 Similarly, the user enters a keystroke sequence corresponding to the city of Chicago, where the keystroke sequence is compared against a dictionary of cities found on the server. The address and dog's breed information are entered in a similar manner. The processing steps between the terminal and the server are shown generally in FIG. 13

Having described preferred embodiments of a novel method and apparatus for entering alphanumeric data from a reduced keyboard (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as defined by the appended claims.

Having thus described the invention with the details and particularity required by the patent laws, what is claimed and desired protected by Letters Patent is set forth in the appended claims.

What is claimed is:

1. A method for inputting alphanumeric data into an electronic device via a reduced keyboard, wherein each key of the reduced keyboard is associated with multiple characters, the method comprising:
detecting a mode of operation of the electronic device;
detecting entry of keystrokes associated with a keystroke sequence from the reduced keyboard;
selecting a dictionary associated with the mode of operation of the electronic device, wherein the dictionary includes stored keystroke sequences respectively corresponding to text associated with the mode of operation;
comparing the keystrokes for the keystroke sequence with the stored keystroke sequences in the dictionary;
identifying at least one matching keystroke sequence from the dictionary; and
displaying the text corresponding to the at least one matching keystroke sequence on a display of the electronic device as a textual representation associated with the keystroke sequence.

2. The method according to claim 1, further comprising:
prioritizing, when a plurality of matching keystroke sequences are identified from the dictionary, to form a prioritized list of matching keystroke sequences, wherein the displaying step comprises displaying the prioritized list of matching keystroke sequences on the display of the electronic device.

3. The method according to claim 2, wherein the prioritizing step comprises prioritizing the plurality of matching keystroke sequences according to frequency of use.

4. The method according to claim 3, further comprising:
selecting a first entry in the prioritized list by activating a key on the reduced keyboard representing a select function.

5. The method according to claim 3, further comprising:
activating a key on the reduced keyboard representing a scrolling function;
scrolling through the prioritized list until the desired text is reached; and
activating a key on the reduced keyboard representing a select function to select the desired text from the prioritized list.

6. The method according to claim 1, wherein the comparing step comprises comparing the keystrokes with the stored keystroke sequences in the dictionary as the keystrokes are detected.

7. The method according to claim 1, wherein the step of detecting the mode of operation comprises:
detecting a user interface associated with a selected program.

8. The method according to claim 1, wherein the step of detecting the mode of operation comprises:
detecting a particular field for a user interface for an associated program selected by a user into which data is being entered.

9. The method according to claim 1, further comprising:
adding, when the comparison fails to obtain the at least one matching keystroke sequence in the dictionary, the keystroke sequence for desired text to the dictionary associated with the mode of operation, wherein the adding step comprises adding the desired text by identifying the characters in the desired text via multiple keystrokes.

10. A method for inputting alphanumeric data into an electronic device via a reduced keyboard, wherein each key of the reduced keyboard is associated with multiple characters, the method comprising:
detecting a mode of operation of the electronic device;
detecting entry of keystrokes associated with a keystroke sequence for desired text from the reduced keyboard, wherein each of the keystrokes represents an alphanumeric character in the desired text;
selecting a dictionary based upon the mode of operation, wherein the dictionary includes stored keystroke sequences respectively corresponding to text associated with the mode of operation;
comparing the keystrokes for the keystroke sequence with the stored keystroke sequences in the dictionary;
identifying at least one matching keystroke sequence from the dictionary; and
displaying the text corresponding to the at least one matching keystroke sequence on a display of the electronic device.

11. The method according to claim 10, further comprising:
prioritizing, when a plurality of matching keystroke sequences are identified from the dictionary, to form a prioritized list of matching keystroke sequences, wherein the displaying step comprises displaying the prioritized list of matching keystroke sequences on the display of the electronic device.

12. The method according to claim 11, wherein the prioritizing step comprises prioritizing the plurality of matching keystroke sequences according to frequency of use.

13. The method according to claim 11, further comprising:
selecting a first entry in the prioritized list by activating a key on the reduced keyboard representing a select function.

14. The method according to claim 10, further comprising:
activating a key on the reduced keyboard representing a scrolling function;
scrolling through the prioritized list until the desired text is reached; and
activating a key on the reduced keyboard representing a select function to select the desired text from the prioritized list.

15. The method according to claim 10, wherein the comparing step comprises comparing the keystrokes with the stored keystroke sequences in the dictionary as the keystrokes are detected.

16. The method according to claim 10, further comprising:
adding, when the comparison fails to obtain the at least one matching keystroke sequence in the dictionary, the keystroke sequence for desired text to the dictionary associated with the mode of operation, wherein the adding step comprises adding the desired text by identifying the characters in the desired text via multiple keystrokes.

17. The method according to claim 10, wherein the step of detecting the mode of operation comprises:
detecting a user interface associated with a selected program.

18. The method according to claim 10, wherein the step of detecting the mode of operation comprises:
detecting a particular field for a user interface for an associated program selected by a user into which data is being entered.

19. A computer-readable medium having computer-executable instructions for performing a method for inputting alphanumeric data into an electronic device via a reduced keyboard, wherein each key of the reduced keyboard is associated with multiple characters, the method comprising:
detecting mode of operation of the electronic device;
detecting entry of a keystrokes associated with a keystroke sequence from the reduced keyboard;
selecting a dictionary associated with the mode of operation, wherein the dictionary includes stored keystroke sequences respectively corresponding to text associated with the mode of operation;
comparing the keystrokes for the keystroke sequence with the stored keystroke sequences in the dictionary;
identifying at least one matching keystroke sequence from the dictionary; and
displaying the text corresponding to the at least one matching keystroke sequence on a display of the electronic device as a textual representation associated with the keystroke sequence.

20. The computer-readable medium according to claim 19, further comprising computer-executable instructions for performing the following steps:
prioritizing, when a plurality of matching keystroke sequences are identified from the dictionary, to form a prioritized list of matching keystroke sequences, wherein the displaying step comprises displaying the prioritized list of matching keystroke sequences on the display of the electronic device.

21. The computer-readable medium according to claim 20, wherein the computer-executable instructions for performing the prioritizing step comprises prioritizing the plurality of matching keystroke sequences according to frequency of use.

22. The computer-readable medium according to claim 21, having further computer-executable instructions for performing the steps comprising:
selecting a first entry in the prioritized list by activating a key on the reduced keyboard representing a select function.

23. The computer-readable medium according to claim 21, having further computer-executable instructions for performing the steps comprising:
activating a key on the reduced keyboard representing a scrolling function;
scrolling through the prioritized list until the desired text is reached; and
activating a key on the reduced keyboard representing a select function to select the desired text from the prioritized list.

24. The computer-readable medium according to claim 19, wherein the computer-executable instructions for performing the comparing step comprise comparing the keystrokes with the stored keystroke sequences in the dictionary as the keystrokes are detected.

25. The computer-readable medium according to claim 19, wherein the computer-executable instructions for performing the step of detecting the mode of operation comprise:
detecting a user interface associated with a selected program.

26. The computer-readable medium according to claim 10, wherein the computer-executable instructions for performing the step of detecting the mode of operation comprise:
detecting a particular field for a user interface for an associated program selected by a user into which data is being entered.

27. The computer-readable medium according to claim 19, having further computer-executable instructions for performing the steps comprising:
adding, when the comparison fails to obtain the at least one matching keystroke sequence in the dictionary, the keystroke sequence for desired text to the dictionary associated with the mode of operation, wherein the adding step comprises adding the desired text by identifying the characters in the desired text via multiple keystrokes.

28. A computer-readable medium having computer-executable instructions for performing a method for inputting alphanumeric data into an electronic device via a reduced keyboard, wherein each key of the reduced keyboard is associated with multiple characters, the method comprising:
detecting mode of operation of the electronic device;
detecting entry of a keystrokes associated with a keystroke sequence for desired text from the reduced keyboard, wherein each of the keystrokes represents an alphanumeric character in the desired text;
selecting a dictionary associated with the mode of operation of the electronic device, wherein the dictionary includes stored keystroke sequences respectively corresponding to text associated with the mode of operation;
comparing the keystrokes for the keystroke sequence with the stored keystroke sequences in the dictionary;
identifying at least one matching keystroke sequence from the dictionary; and
displaying the text corresponding to the at least one matching keystroke sequence on a display of the electronic device.

29. The computer-readable medium according to claim 28, having further computer-executable instructions for performing the steps comprising:
prioritizing, when a plurality of matching keystroke sequences are identified from the dictionary, to form a prioritized list of matching keystroke sequences, wherein the displaying step comprises displaying the prioritized list of matching keystroke sequences on the display of the electronic device.

30. The computer-readable medium according to claim 29, wherein the computer-executable instructions for performing the prioritizing step comprise prioritizing the plurality of matching keystroke sequences according to frequency of use.

31. The computer-readable medium according to claim 29, having further computer-executable instructions for performing the steps comprising:
selecting a first entry in the prioritized list by activating a key on the reduced keyboard representing a select function.

32. The computer-readable medium according to claim 28, having further computer-executable instructions for performing the steps comprising:
activating a key on the reduced keyboard representing a scrolling function;
scrolling through the prioritized list until the desired text is reached; and
activating a key on the reduced keyboard representing a select function to select the desired text from the prioritized list.

33. The computer-readable medium according to claim 28, wherein the computer-executable instructions for performing the comparing step comprise comparing the keystrokes with the stored keystroke sequences in the dictionary as the keystrokes are detected.

34. The computer-readable medium according to claim 28, having further computer-executable instructions for performing the steps comprising:
adding, when the comparison fails to obtain the at least one matching keystroke sequence in the dictionary, the keystroke sequence for desired text to the dictionary associated with the mode of operation, wherein the adding step comprises adding the desired text by identifying the characters in the desired text via multiple keystrokes.

35. The computer-readable medium according to claim 28, wherein the computer-executable instructions for performing the step of detecting the mode of operation comprise:
detecting a user interface associated with a selected program.

36. The computer-readable medium according to claim 28, wherein the computer-executable instructions for performing the step of detecting the mode of operation comprise:
detecting a particular field for a user interface for an associated program selected by a user into which data is being entered.

37. In a mobile telephone, a text input system for entering alphanumeric data comprising:
an input device having a plurality of inputs, wherein each of the plurality of inputs is associated with a plurality of characters;
an output device for supplying output to a user; and
a processor, coupled to the input device and the output device, for determining a mode of operation of the mobile telephone, detecting activation of the inputs on the input device, selecting, upon activation of the inputs, a dictionary associated with the mode of operation of the mobile telephone, wherein each entry in the dictionary includes an input sequence and associated text corresponding to the mode of operation of the mobile telephone, and determining text corresponding to the inputs from the input device based upon information stored in the dictionary.

38. In a computer system, a text input system for entering alphanumeric data comprising:
an input device having a plurality of inputs, wherein each of the plurality of inputs is associated with a plurality of characters;
an output device for supplying output to a user; and
a processor, coupled to the input device and the output device, for determining a mode of operation of the computer system, detecting activation of the inputs on the input device, selecting, upon activation of the inputs, a dictionary associated with the mode of operation of the computer system, wherein each entry in the dictionary includes an input sequence and associated text corresponding to the mode of operation of the computer system, and determining text corresponding to the inputs from the input device based upon information stored in the dictionary.

39. A method for inputting alphanumeric data into an electronic device via a reduced keyboard, wherein each key of the reduced keyboard is associated with multiple characters, the electronic device arranged to access a storage device arranged separate from the electronic device, the method comprising:
detecting a mode of operation of the electronic device;
detecting entry of keystrokes associated with a keystroke sequence from the reduced keyboard;
selecting a dictionary, located in the storage device, associated with the mode of operation of the electronic device, wherein the dictionary includes stored keystroke sequences respectively corresponding to text associated with the mode of operation;
comparing the keystrokes for the keystroke sequence with the stored keystroke sequences in the dictionary; and
identifying at least one matching keystroke sequence from the dictionary.

40. A method for inputting alphanumeric data into an electronic device via a reduced keyboard, wherein each key of the reduced keyboard is associated with multiple characters, the electronic device arranged to wireless access to a storage device over a wireless network, the method comprising:
detecting a mode of operation of the electronic device;
detecting entry of keystrokes associated with a keystroke sequence from the reduced keyboard;
selecting a dictionary associated with the mode of operation of the electronic device stored on the storage device via the wireless network, wherein the dictionary includes stored keystroke sequences respectively corresponding to text associated with the mode of operation;
comparing the keystrokes for the keystroke sequence with the stored keystroke sequences in the dictionary; and
identifying at least one matching keystroke sequence from the dictionary.

41. A computer-readable medium having computer-executable instructions for performing a method for inputting alphanumeric data into an electronic device via a reduced keyboard, wherein each key of the reduced keyboard is associated with multiple characters, the electronic device arranged to access a storage device arranged separate from the electronic device, the method comprising:
detecting a mode of operation of the electronic device;
detecting entry of keystrokes associated with a keystroke sequence from the reduced keyboard;
selecting a dictionary, located in the storage device, associated with the mode of operation of the electronic device, wherein the dictionary includes stored keystroke sequences respectively corresponding to text associated with the mode of operation;
comparing the keystrokes for the keystroke sequence with the stored keystroke sequences in the dictionary; and
identifying at least one matching keystroke sequence from the dictionary.

42. A computer-readable medium having computer-executable instructions for performing a method for inputting alphanumeric data into an electronic device via a reduced keyboard, wherein each key of the reduced keyboard is associated with multiple characters, the electronic device arranged to wireless access to a storage device over a wireless network, the method comprising:
detecting a mode of operation of the electronic device;
detecting entry of keystrokes associated with a keystroke sequence from the reduced keyboard;
selecting a dictionary associated with the mode of operation of the electronic device stored on the storage device via the wireless network, wherein the dictionary includes stored keystroke sequences respectively corresponding to text associated with the mode of operation;
comparing the keystrokes for the keystroke sequence with the stored keystroke sequences in the dictionary; and
identifying at least one matching keystroke sequence from the dictionary.

43. In a computer system having access to a remote storage device, a text input system for entering alphanumeric data, comprising:
an input device having a plurality of inputs, wherein each of the plurality of inputs is associated with a plurality of characters;
an output device for supplying output to a user; and
a processor, coupled to the input device, the output device, and the remote storage device for determining a mode of operation of the computer system, detecting activation of the inputs on the input device, selecting, upon activation of the inputs, a dictionary associated with the mode of operation of the computer system from the remote storage device, wherein each entry in the dictionary includes an input sequence and associated text corresponding to the mode of operation of the computer system, and determining text corresponding to the inputs from the input device based upon information stored in the dictionary.

44. In a computer system having wireless access to a remote storage device over a wireless network, a text input system for entering alphanumeric data, comprising:
an input device having a plurality of inputs, wherein each of the plurality of inputs is associated with a plurality of characters;
an output device for supplying output to a user; and
a processor, coupled to the input device and the output device, and wirelessly coupled to the remote storage device over the wireless network, for determining a mode of operation of the computer system, detecting activation of the inputs on the input device, selecting, upon activation of the inputs, a dictionary associated with the mode of operation of the computer system from the remote storage device, wherein each entry in the dictionary includes an input sequence and associated text corresponding to the mode of operation of the computer system, and determining text corresponding to the inputs from the input device based upon information stored in the dictionary.
